(19) United States
(12) Patent Application Publication
(10) Pub. No.: US 2012/0321957 A1
(43) Pub. Date: Dec. 20, 2012

(54) CONDUCTOR HAVING A PERMEATION REGION

(75) Inventors: Tim Schaefer, Harztor (DE); Andreas Gutsch, Luedinghausen (DE)

(73) Assignee: LI-TEC BATTERY GMBH, Kamenz (DE)

(21) Appl. No.: 13/504,913

(22) PCT Filed: Oct. 25, 2010
(86) PCT No.: PCT/EP2010/006509

§ 371 Date: Aug. 22, 2012

(30) Foreign Application Priority Data
Oct. 29, 2009 (DE) 10 2009 051 214.4

(51) Int. Cl. H01M 4/131; H01M 4/04; H01M 4/70

(52) U.S. Cl. 429/221; 429/233; 429/223; 429/224; 429/231.5; 429/231.1; 427/58

(57) ABSTRACT

Conductor for an electrode of an electrochemical energy storage means, in particular of, essentially, prismatic shape, with a passage region through which electrons may enter into the conductor or through which electrons may exit from the conductor.

### CROSS-REFERENCE TO RELATED APPLICATIONS

This application is a national stage application under 35 U.S.C. §371 of International Application No. PCT/EP2010/006509, filed Oct. 25, 2010 and published as WO 2011/050936, which claims priority to German patent application number DE 10 2009 051 214.4, filed Oct. 29, 2009, the entirety of each of which is hereby incorporated herein by reference.

### SUMMARY

The present invention relates to a conductor, an electrode with said conductor, an electrochemical energy storage means with two of said electrodes, a battery with at least one of such electrochemical energy storage means, and a method for producing an electrode. The present invention will be described in connection with lithium-ion batteries. It should be noted that the present invention may also be applied independently of the type of the battery or independently of the type of the supplied drive.

Batteries having multiple electrochemical energy storage means are known from the prior art. Some types of these batteries have in common that their respective power density (kW/kg) is considered to be too low.

The underlying object of the present invention is therefore to increase the power density of such a battery.

According to the present invention, this is achieved by means of the teaching herein. Preferred embodiments of the present invention are described herein.

A conductor according to the present invention is provided for an electrode of an electrochemical energy storage means. The conductor is, in particular, of an essentially prismatic shape. The conductor has at least one permeation region (“Durchgangsbereich”) through which electrons enter into the conductor, or through which they exit from the conductor. The conductor is characterized in that at least one of the permeation regions has at least a plurality of first contact bodies. At least one first contact body is formed, essentially, rod-shaped. At least one first contact body has a free end and a fixed end. The fixed end is provided to be connected to the passage region. At least one first contact body extends from the at least one first permeation region into the environment.

According to the present invention, “a conductor” refers to a means, which is used, in particular, for conducting electrons. Furthermore, the conductor is used in particular for heat conduction. Preferably, the conductor is connected with an active electrode mass (or, respectively, an active material) and/or indirectly with an electrical load, in particular, connected by means of a feed line or, respectively, by means of a connecting cable. The conductor temporarily exchanges electrons with the active electrode mass and/or with the electrical load. Preferably, the conductor temporarily exchanges heat energy with the active electrode mass and/or with the feed line. Preferably, the conductor comprises at least one electrically conductive material. Particularly preferably, at least one material of the conductor is selected from a group consisting of carbon, aluminum, copper, nickel, or any other metal.

According to the present invention, the term “electrode” refers to a means, which is used, in particular, for receiving and releasing electrons. In particular, the electrode is used to receive and to release ions. An electrode has a conductor and at least an active electrode mass.

Preferably, an electrode is in electrical interaction with another electrode of opposite polarity by means of an electrolyte. According to the present invention, the term “an active electrode mass” refers to a means, which is used, in particular, for the conversion of electrical energy into chemical energy and vice versa. In particular, an active electrode mass is used for storing energy in chemical form.

According to the present invention, the term “an electrochemical energy storage means” refers to a means, which, in particular, is used for receiving, releasing, and/or for storing electrical energy. For this purpose, the electrochemical energy storage means has at least two electrodes of different polarity, as well as an electrolyte. Preferably, electrodes of different polarity are separated by a separator. The separator takes up, in particular, at least a portion of the electrolyte, and is made, in particular, in an ion-conductive manner, but not in an electron-conductive manner. Preferably, the electrochemical energy storage means has a plurality of electrodes which are arranged, together with a plurality of separators, to form an electrode stack. Here, a separator is arranged between two electrodes of different polarity, respectively.

Preferably, the conductor has an essentially prismatic shape. Preferably, the shape of the conductor is adjusted to the geometry of the electrode, the electrochemical energy storage means and/or the associated battery. Preferably, the conductor is provided as a thin sheet or film. Preferably, the conductor has a connection region for connecting, in particular, a current-supply line. Preferably, the conductor has a permeation region, in particular, for contacting an active electrode mass and for the passage of electrons. Preferably, a connection region and a permeation region are associated with a lateral surface area of the conductor. Preferably, a conductor has at least two permeation regions (in the sense of the present invention also: passage region).

According to the present invention, the term “permeation or passage region” refers to a region of a lateral surface area of the conductor. Thus, on one side, the permeation region borders on the core region of the conductor and, on the other side, on the surrounding region of the conductor. A permeation region extends, preferably, at least over the major part of a lateral surface area of the conductor. Preferably, a conductor according to the present invention has at least two permeation regions. In case the conductor is provided as a thin-walled plate with two largest, each other opposing lateral surface areas, at least one passage region is assigned to one of said largest lateral surface areas. Preferably, each of said largest lateral surface areas has a passage region.

According to the present invention, the term “a first contact body” refers to a solid body, which is used, in particular, for conducting electrons. A first contact body is, preferably, connected to a passage region of the conductor in an electrically conductive manner. During the operation of the conductor, electrons flow from an active electrode mass through said at least one first contact body into the conductor, or flow in the reverse direction. This results, that the first contact body causes, in particular, an enlargement of the contact region between the conductor and the active electrode mass. The first contact body has a bound end, which is connected with a passage region of the conductor and, in particular, in a stock-locking manner. Furthermore, a first contact body has a free end, which is in opposite of the bound end and, which extends into the environment. Preferably, a first contact body extends at an angle between 0° and 90° from a passage region. Preferably, the free end of a first contact body extends into an active electrode mass. Preferably, a passage region has a majority, more preferably, a plurality of first contact bodies. Preferably, a passage region is covered, predominantly, with first contact bodies. It is not necessary, that a first contact body extends along a symmetry axis. A first contact body has, preferably, an irregular, in particular, a production-related shape. Preferably, a first contact body is curved, bent, and/or twisted, at least partially. According to the present invention, a first contact body is formed, essentially, in a rod-shape manner. In this regard, variations of the rod-shape manner and in particular, manufacturing-variations are permissible. Thus, a first contact body has preferably, the shape of a flat elevation similar to a hill, the shape of a flag, a rod, or a tube. Preferably, a first contact body has a thickness of between 0.01 and 1 micrometer, particularly preferably, between 0.01 and 0.1 micron. Preferably, a first contact body has a length between 0.1 to 100 microns, particularly preferably, between 0.1 to 10 micrometers. A first contact body has at least one electrically-conductive material. Preferably, a first contact body has a material, selected from a group consisting of carbon, aluminum, nickel, copper, potassium titanate, titanium, carbide, silicon carbide, titanium dioxide, zinc oxide, magnesium oxide, tin oxide, indium oxide, and aluminum carbide. Preferably, a first contact body and a conductor have at least one identical material. Preferably, for a first contact body a material is selected, which forms or, respectively, creates a permanent chemical and/or physical bond with carbon, a component of the active electrode mass and/or a component of the separator.

The lateral surface areas of the electrically conductive first contact bodies provide the electrons an enlarged passage surface area, in comparison to the mere surface area of the passage region. In particular, the current density and the electric resistance are reduced. Thus, the permeability of a lateral surface area or, respectively, of a passage region of a conductor is increased for electrons, the power density of the corresponding electrode as well as of the corresponding battery cell is also increased and the underlying problem of the present invention is solved. Furthermore, a first contact body improves by means of a chemical and/or physical bonding, in particular, the cohesion of the conductor and the active electrode mass.

Below, preferred embodiments of the present invention will be described.

Preferably, a conductor according to the present invention is at least partially covered by a first substance. Preferably, the passage region of the conductor is at least partially covered with a first substance. Preferably, the first substance comprises particles. Preferably, the first substance or, respectively, its particles are electrically conductive. Preferably, the first substance or, respectively, its particles are thermally conductive. Preferably, a passage region of the conductor is completely covered with a first substance. Preferably, the layer thickness of the first substance is dimensioned smaller than the wall thickness of the conductor. Preferably, the coating is made with the first substance such, that only few of its particles are arranged above each other. Preferably, the particles are, essentially, spherically shaped. Preferably, the particles of the first substance are formed geometrically indefinite and irregularly. Preferably, the shape of the particles of the first substance is in the form of chips. Preferably, the first substance is initially in powder form. Preferably, the diameter of a particle of the first substance is less than the wall thickness of the conductor and/or less than the thickness of the coating with the first substance. Preferably, the diameter of a particle of the first substance is less than the length of a first contact body. Preferably, the first substance comprises at least an electrically conductive material, particularly preferably, carbon material. Preferably, the first substance is a mixture which also comprises a component of an active electrode mass. Preferably, the first substance is a mixture, which also comprises a component of the separator. Preferably, the coating with the first substance refers to a hard carbon layer. Preferably, the first substance covers a predetermined portion of a passage region. Preferably, the first substance is made in form of circular areas or of spaced strips. Preferably, the active electrode mass is applied onto the first substance, so that the first substance is at least partially disposed between the conductor and the active electrode mass.

Preferably, at least a first contact body extends into the first substance. Preferably, at least a first contact body extends through the first substance and protrudes out, in particular, with its free end, of the first substance. Preferably, a first contact body is chemically and/or physically bound with the first substance or, respectively, at least with one of its particles. The contact between the first substance and the at least one first contact body is made such that temporarily a flow of electrons from an active electrode mass occurs through said first contact body into the conductor. The flow of electrons may also occur in the reverse direction. In this case, a first contact body serves, in particular, to increase the surface area of the conductor. Preferably, most of the first contact bodies are made as stated above.

Preferably, at least two of the first contact bodies are connected with each other. In particular, their free ends are connected with each other. Preferably, the free ends of two first contact bodies are connected with each other. Preferably, the connection of at least two first contact guides occurs via knotting, linking, weaving, braiding, mutual wrapping of the free ends. Preferably, two first bodies form a loop by means of connection of their free ends. Preferably, at least three first contact bodies are connected as stated above. Preferably, the passage region has a plurality of interconnected first contact bodies. Preferably, most of the first contact bodies are connected with at least one additional first contact body, respectively. Preferably, the connections of at least two first contact bodies are, respectively, made irregularly and/or depending on the employed production process. Preferably, some of the first contact bodies are connected with at least one further contact body, respectively. Preferably, up to 1/10, up to 2/10, up to 3/10, up to 4/10, up to 5/10, up to 6/10, up to 7/10, up to 8/10, up to 9/10 of the first contact bodies are connected with at least one further first contact body, respectively.

Preferably, an electrode, which is provided, in particular, for an electrochemical energy storage means, has also a conductor according to the present invention. Furthermore, the electrode has at least an active electrode mass. The active electrode mass is used to store energy, to supply energy and/or to exchange electrons with the conductor. Further, the active electrode mass is used, in particular, for the conversion of electrical energy into chemical energy and vice versa. Preferably, the active electrode mass is applied onto the conductor. Preferably, the active electrode mass is applied onto a passage region of the conductor. Preferably, a first substance is at least partially disposed between the active electrode mass and the conductor. Preferably, at least some first contact bodies extend into the active electrode mass. Preferably, particles of the active electrode mass are chemically and/or physically bound to some of the first contact bodies. Preferably, an active electrode mass exchanges temporarily electrons with the conductor, wherein said exchange is carried out, in particular, within a passage region of the conductor. Preferably, the shape of the electrode resembles, essentially, the geometry of the conductor. Preferably, the active electrode mass is provided in a pasty manner. Preferably, the layer thickness of the active electrode mass is less than the wall thickness of the conductor, provided that when producing the electrode, a focus is made on low electrical resistance and good heat transfer. Preferably, the layer thickness of the active electrode mass is greater than the wall thickness of the conductor, in particular, provided that a focus is made on a high energy density of the electrode. Preferably, the, essentially, plate-shaped conductor is provided with two passage regions, which are in opposite to each other.

Preferably, an active electrode mass is applied onto both passage regions. The material of the active electrode masses comprises, preferably, the same composition. Preferably, the layer thicknesses of the two active electrodes masses are different. Thus, one active electrode mass is produced in terms of high power density, the other active electrode mass is produced in terms of high energy density.

Preferably, an electrochemical energy storage means comprises at least two electrodes, with one conductor according to the present invention, as well as one separator, respectively. Preferably, one of the electrodes is used as the negative electrode or, respectively, as the anode, while the second electrode is used as the positive electrode or, respectively, as the cathode. The separator mentioned, is made in an ion-conductive manner and comprises the electrolyte or, respectively, the electrolytic solution, at least partially. However, the separator is not made for conducting electrons. The separator is arranged between the electrodes of different polarity such, that the active electrode masses of the electrodes contact different contact regions of the separator. Said contact regions are arranged on the lateral surface areas of the separator.

Preferably, a separator of an electrochemical energy storage means has a contact region which is equipped with a plurality of, essentially, rod-shaped second contact bodies. The second contact bodies differ from the first contact bodies, in particular, in that they can not conduct electrons. Preferably, the second contact bodies are made of an electrically non-conductive material, respectively. Preferably, the second contact bodies are longer and thicker than the first contact bodies. Preferably, the second contact bodies are only slightly shorter than the layer thickness of the adjacent active electrode mass. Preferably, a second contact body has an irregular shape, which is characterized, in particular, by depressions and/or elevations, which enlarge the surface area. Preferably, a second contact body is provided with at least one undercut surface area.

Preferably, a battery has at least one electrochemical energy storage means with a conductor according to the present invention. Preferably, a battery has two or more aforementioned electrochemical energy storage means. Preferably, the number of electrochemical energy storage means of the battery is integer and divisible by four without residual. Preferably, the electrochemical energy storage means of the battery are in series and/or in parallel connection, electrically connected. Preferably, the battery has several groups, each of 4 or more electrochemical energy storage means, connected in series. Preferably, said groups are mutually connected in series and/or in parallel.

According to the present invention, preferably, a separator is used, which is not or only poorly electron-conductive, and which has a support, which is at least partially permeable for material. The support is, preferably, coated on at least one side with an inorganic material. As a support, which is at least partially permeable for material, preferably, an organic material is used, which is, preferably, made as a nonwoven fleece. The organic material, which comprises, preferably, a polymer and particular preferably a polyethylene terephthalate (PET), is coated with an inorganic, preferably, an ion-conducting material, which further preferably, is ionically conductive within a temperature range from −40° C. to 200° C. The inorganic material comprises preferably at least one compound selected from the group consisting of oxides, phosphates, sulfates, titanates, silicates, aluminosilicates with at least one of the elements Zr, Al, Li, particularly preferably, zirconium oxide. Preferably, the inorganic ion-conducting material has particles with a maximum diameter of less than 100 nm. Such a separator is sold, for example, under the trade name “Separion” by the Evonik AG in Germany.

Preferably, at least one electrode of the electrochemical energy storage means, has particularly preferably, at least one cathode, one compound with the formula LiMPO₄, wherein M is at least one transition metal cation of the first row of the Periodic Table of the Elements. Said transition metal cation is, preferably, selected from the group consisting of Mn, Fe, Ni and Ti, or a combination of these elements. The compound has, preferably, an olivine structure, preferably a parent olivine, wherein Fe is particularly preferred.

In a further embodiment, preferably, at least one electrode of the electrochemical energy storage means, comprises, particularly preferably, at least one cathode, one lithium manganate, preferably, LiMn₂O₄ of the spinel-type, a lithium cobaltate, preferably, LiCoO₂, or a lithium nickelate, preferably LiNiO₂, or a mixture of two or three of these oxides, or a lithium composite oxide, which comprises manganese, cobalt and nickel.

The cathodic electrode comprises in a preferred embodiment, at least one active electrode mass or, respectively, active material, wherein the active material is a mixture of a lithium-nickel-manganese-cobalt composite oxide (NMC), which is not present in a spinel-structure, with a lithium-manganese oxide (LMO) in spinel structure. It is preferred that the active material has at least 30 mol %, preferably, at least 50 mol % NMC as well as at the same time at least 10 mol %, preferably at least 30 mol % LMO, each based on the total mol number of the active material of the cathodic electrode (i.e. not based on the cathodic electrode as a whole, which in addition to the active material may still have conductivity additives, binders, stabilizers, etc.). It is preferred that NMC and LMO together have at least 60 mol % of the active material, more preferably at least 70 mol %, further preferably, at least 80 mol %, more preferably at least 90 mol %, each based on the total mol number of the active material of the cathodic electrode (i.e. not based on the cathodic electrode as a whole, which in addition to the active material may still have conductivity additives, binders stabilizers, etc.). It is further preferred, that the active material is made, essentially, of NMC and LMO, and thus, does not comprise any other active materials, in a range of more than 2 mol %. Moreover, it is further preferred, that the material, applied onto the support is, essentially, active material, i.e. 80 to 95 weight percent of the material applied onto the support of the cathodic electrode, is said active material, more preferably, 86 to 93 weight percent, each based on the total weight of the material (i.e. based on the cathodic electrode without a support as a whole, which in addition to the active material still may have conductivity additives, binder, stabilizers, etc.). With respect to the ratio in weight fractions of NMC as an active material to LMO as active material, it is preferred, that said ratio is from 9 (NMC):1 (LMO) up to 3 (NMC):7 (LMO), wherein 7 (NMC):3 (LMO) up to 3 (NMC):7 (LMO) is preferred, and wherein 6 (NMC):4 (LMO) up to 4 (NMC):6 (LMO) is more preferred.

Preferably, an electrode is produced using a conductor according to the present invention. For this, first, a conductor according to the present invention is provided. Subsequently, a first substance is applied onto the conductor, in particular, applied onto its passage region. The first substance or, respectively, its particles form a bonding in a chemically and/or physically manner with a plurality of the first contact bodies. Preferably, the first substance is applied in a predetermined pattern onto the passage region of the conductor. Thus, the passage region of the conductor is, preferably, covered with the first substance only up to a predetermined portion. Preferably, the first substance is applied with a layer thickness, which is less than the wall thickness of the conductor. Furthermore, an active electrode mass is applied onto the passage region. The first substance is at least partially disposed between the active electrode mass and the passage region of the conductor. The first substance is, preferably, a mixture, comprising carbon, a material of the active electrode mass and/or a material of the separator.

Preferably, a battery with at least one conductor according to the present invention is provided for supplying a motor vehicle drive.

Further advantages, characteristics, and possible uses of the present invention will become apparent from the following description in connection with the figures.

### BRIEF DESCRIPTION OF THE DRAWINGS

FIG. 1 shows a conductor according to the present invention in a side view (FIG. 1a) and in a perspective view (FIG. 1b).

FIG. 2 shows an electrode with a conductor according to the present invention with two passage regions and a connecting region, with two layers with a first substance and with two active electrodes masses in a side view.

FIG. 3 shows an electrochemical energy storage means with two conductors and electrodes according to the present invention in an exploded view.

### DETAILED DESCRIPTION

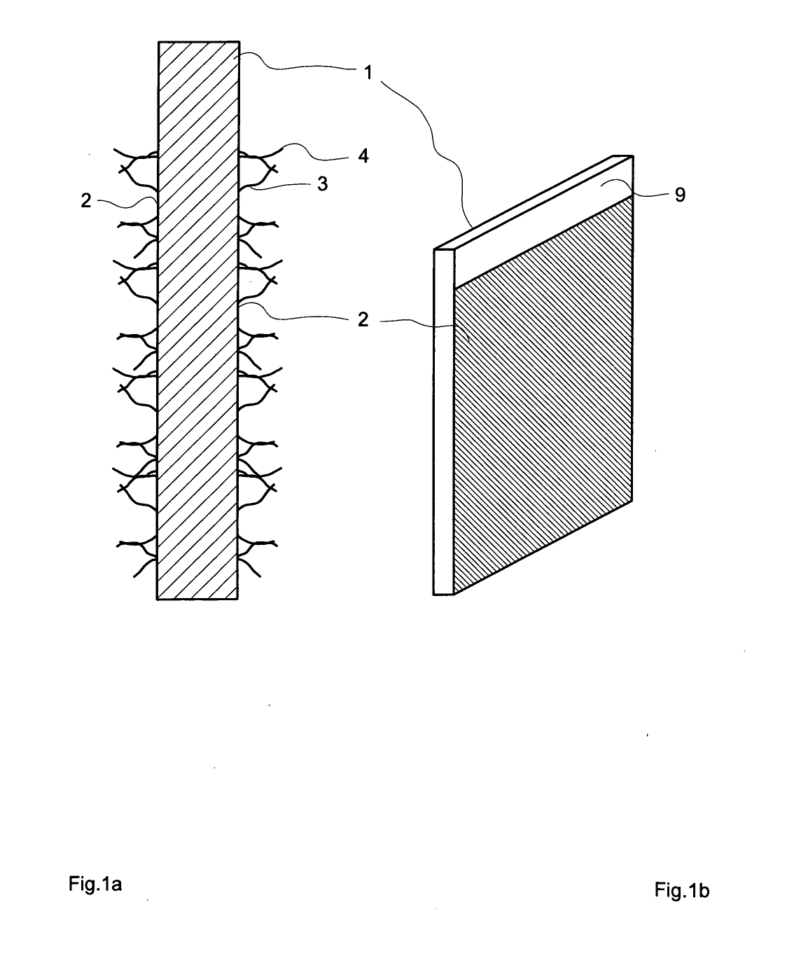

FIG. 1a shows a conductor 1 according to the present invention is in a not to scale side view and in cross section. The conductor 1 has two passage regions 2, which are assigned to opposite lateral surface areas of the conductor 1. A passage region 2 extends over the major part of a lateral surface area of the conductor 1. Each of said passage regions 2 has a plurality of first contact bodies 3. Said first contact bodies 3 have a free end 4, respectively. The first contact bodies 3 extend from a passage region 2 into the environment of the conductor 1. A first contact body 3 has an irregular geometry. The average diameter of the first contact bodies 3 is 20 to 30 nm. The length of each of the first contact bodies 3 is smaller than the wall thickness of the conductor 1. The first contact bodies 3 comprise predominantly aluminum carbide. The conductor 1 comprises predominantly aluminum. The figure shows that some of the first contact bodies 3 are connected with at least one additional first contact body 3 and sporadically form loops. Other first contact bodies 3 stand alone.

FIG. 1b shows a perspective view of a conductor 1 with a passage region 2, which is illustrated shaded. This passage region 2 is assigned to a lateral surface area of the conductor 1 and extends over most part of the lateral surface area. A connection region 9 is also assigned to the same lateral surface area. In FIG. 1b, the passage region 2 is illustrated for simplicity without a first contact body. Also, it is not shown that the conductor 1 is connected in the connection region 9 to a feed line.

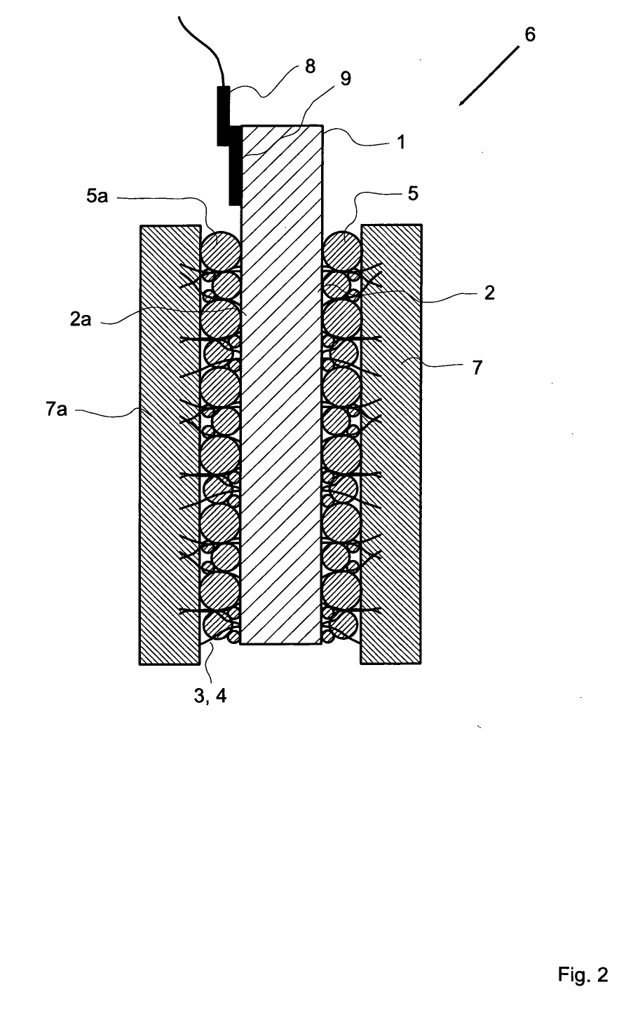

FIG. 2 shows an electrode 6 with a conductor 1 according to the present invention with two passage regions 2, 2a, and with connection region 9, with two layers with a first substance 5, 5a, and with two active electrode masses 7, 7a is a side view. In the connection region 9 of the conductor 1, a feed line is screwed on. The passage regions 2, 2a are assigned to different and opposite lateral surfaces areas of the conductor 1. From these passage regions 2, 2a, first contact bodies 3 extend through layers of the first substance 5, 5a into the active electrode masses 7, 7a. The active electrode masses 7, 7a have a mixture of carbon and electrochemically active constituents. In FIG. 2, the thicknesses of the individual layers are shown only schematically and not to scale. The layers of the first substance 5, 5a have particles of different sizes. Only for a simplified illustration, are said particles drawn as circles. In reality, the particles are irregularly shaped, wherein their shape is due to the manufacturing processes used. The active electrode mass 7, 7a comprises a mixture of a lithium-nickel-manganese-cobalt composite oxide (NMC), which is not present in a spinel-structure, with a lithium-manganese oxide (LMO) in spinel structure.

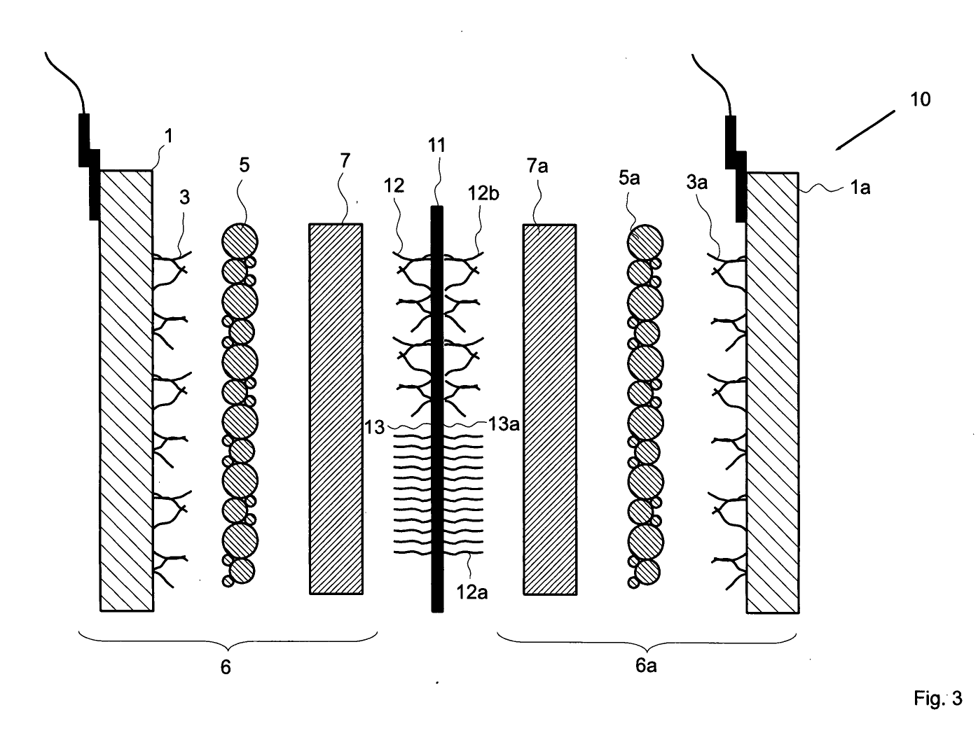

FIG. 3 shows an electrochemical energy storage means 10 with two electrodes 6, 6a and a separator 11. The structure of the electrodes 6, 6a corresponds, essentially, to the assembly 2 of FIG. 2. The separator 11 has second contact bodies 12, 12a, 12b. Said second contact bodies 12, 12a, 12b extend from the contact regions 13, 13a into the environment. The material of the separator 11 and the second contact bodies 12, 12a, 12b is, essentially, equal. The second contact bodies 12, 12b are irregularly shaped. Only for illustration of an alternative embodiment, are also the second contact bodies 12a shown. These extend, essentially, linearly from the contact regions 13 13a. In the assembled state of the electrochemical energy storage means 10, the second contact bodies 12, 12a, 12b extend into the respective adjacent active electrode mass or, respectively, into the active material. The separator 11 has a part of the electrolyte, in this case, lithium ions. Before, the separator 11 was soaked with an electrolyte solution and the solvent was evaporated. The separator is made of Separion. The pasty active electrode mass 7 has a LiFePO₄ in a olivine structure and acts as a cathode or, respectively, as a positive electrode. The active electrode mass 7a acts as the anode and has an amorphous carbon modification, which is made as a hard carbon layer.

1-11. (canceled)

12. A conductor for an electrode of an electrochemical energy storage means, in particular of, essentially, prismatic shape, with a passage region through which electrons may enter into the conductor or may exit from the conductor, of which the passage region has a plurality of, essentially, rod-shaped, first contact bodies, at least one first contact body has a free end, and the at least one first contact body extends from the passage region into the environment,
wherein for a first contact body a material is selected, which forms or, respectively, creates a permanent chemical and/or physical bond with carbon, a component of an active electrode mass, and/or a component of a separator.

13. The conductor according to claim 12, wherein:
the passage region is covered at least partially by a first substance,
at least one first contact body, in particular, its free end, extends into the first substance,
at least a first contact body is connected with a first substance, and/or
at least two of the first contact bodies, in particular, their free ends, are connected to each other.

14. The conductor according to claim 12, wherein:
the passage region is covered at least partially by a first substance,
at least one first contact body, in particular, its free end, extends into the first substance,
at least one first contact body forms a chemical and/or physical bond with a first substance or, respectively, with at least one of its particles, and/or
at least two of the first contact bodies, in particular, their free ends, are connected to each other.

15. The conductor according to claim 12, wherein particles of the active electrode mass form a chemical and/or physical bond with some of the first contact bodies.

16. An electrode, in particular, for an electrochemical energy storage means, with a conductor according to claim 12 and an active electrode mass, which is provided for storing energy, for supplying energy and/or for exchanging electrons with the conductor, in particular, with a passage region of the conductor.

17. An electrochemical energy storage means, comprising:
two electrodes according to claim 16, and
a separator, which is arranged between the two electrodes, in particular, between the respective active electrode masses of the two electrodes.

18. An electrochemical energy storage means according to claim 17, wherein:
the separator has at least one contact region,
the contact region is provided with a plurality of, essentially, rod-shaped, second contact bodies,
at least a second contact body extends from the contact region into the environment, and
at least a second contact body extends into an adjacent active electrode mass.

19. An electrochemical energy storage means according to claim 17, with at least one separator, which is not or only poorly electron-conductive, and which includes one support, at least partially formed of a permeable material, wherein the support is coated on at least one side with an inorganic material,
wherein, as support, which is at least partially permeable for material, preferably, an organic material is used, which is configured as a non-woven fleece, wherein the organic material is a polymer, wherein the organic material is coated with an inorganic ion-conductive material, which further is ion-conductive in a temperature range from −40° C. to 200° C., wherein the inorganic material is at least one compound selected from the group consisting of oxides, phosphates, sulfates, titanates, silicates, aluminosilicates, at least comprising one of the elements Zr, Al, Li, particularly preferably, zirconium oxide, and wherein the inorganic ion-conductive material, has particles with a maximum diameter of less than 100 nm.

20. An electrochemical energy storage means according to claim 17, comprising at least one electrode which includes a compound having the formula LiMPO₄, wherein M is at least one transition metal cation of the first row of the Periodic Table of the elements, wherein said transition metal cation is selected from the group consisting of Mn, Fe, Ni, and Ti, or a combination of these elements, and wherein the compound has an olivine-structure.

21. An electrochemical energy storage means according to claim 17, comprising at least one electrode which includes a lithium manganate, a lithium cobaltate, or a lithium nickelate, or a mixture of two or three of these oxides, or a lithium composite oxide which comprises manganese, cobalt, and nickel.

22. An electrochemical energy storage means according to claim 17, wherein a cathodic electrode comprises at least one support on which at least one active material is applied or deposited, wherein the active material is a mixture of a lithium-nickel-manganese-cobalt composite oxide (NMC) which has no spinel-structure, and a lithium-manganese oxide (LMO) with a spinel-structure.

23. A battery comprising at least one electrochemical energy storage means according to claim 17.

24. A method for producing an electrode according to claim 16, comprising:
a) providing a conductor;
b) applying a first substance onto the conductor, in particular, onto its passage region, wherein the first substance is chemically and/or physically bonded to at least one first contact body; and
c) applying an active electrode mass onto the first substance.
